(19) United States
(12) Patent Application Publication
(10) Pub. No.: US 2020/0233379 A1
(43) Pub. Date: Jul. 23, 2020

(54) CELL OBSERVATION DEVICE

(71) Applicant: SHIMADZU CORPORATION, Kyoto-shi, Kyoto (JP)

(72) Inventors: Yusuke AOI, Kyoto-shi (JP); Katsutoshi KIMURA, Kyoto-shi (JP)

(73) Assignee: SHIMADZU CORPORATION, Kyoto-shi, Kyoto (JP)

(21) Appl. No.: 16/489,949

(22) PCT Filed: Mar. 3, 2017
(86) PCT No.: PCT/JP2017/008567

§ 371 Date: Aug. 29, 2019

(51) Int. Cl. G03H 1/04; G06T 3/40; G03H 1/00

(52) U.S. Cl. CPC G03H 1/0443; G06T 3/40; G03H 1/0005; G03H 2210/12; G03H 2001/0452; G03H 2210/55; G03H 2001/005

(57) ABSTRACT

The present invention is a cell observation device in which two-dimensional distributions of phase information and intensity information are computed based on hologram data obtained with a holographic microscope. An image display screen (100) displayed on a display unit includes an image display area (120) having two image display frames (121, 122). A phase image and intensity image corresponding to the same observation range on a cell culture plate (12), on which the cells to be observed are cultured, are displayed in the image display frames (121, 122), respectively. The wells on the plate, which are almost invisible on the phase image, are clearly visible on the intensity image. Conversely, the biological cells, which are almost invisible on the intensity image, are observable on the phase image. An observer specifies the range to be observed within a well on the intensity image, and subsequently enlarges the image corresponding to that range so as to observe the cells in detail on the phase image. Thus, the cells which are present within a desired range in the well can be assuredly observed.

### TECHNICAL FIELD

The present invention relates to a cell observation device for observing the state of biological cells, and more specifically, to a cell observation device configured to create a phase image, intensity image or other types of images of an object by computationally processing a hologram which records interference fringes of object waves and reference waves in a digital holographic microscope.

### BACKGROUND ART

In recent years, studies which use pluripotent stem cells, such as induced pluripotent stem cells (iPS cells) or embryonic stem cells (ES cells), have been popularly conducted in the area of regenerative medicine. In general, biological cells are transparent and difficult to observe with a normal optical microscope. Accordingly, phase-contrast microscopes have been commonly used for the observation of such cells.

A problem with the phase-contrast microscope is that it requires the focusing operation before recording the microscopic image, so that an impractically large amount of time is required for the measurement when it is necessary to take a microscopic image for each of the small areas defined by dividing a large observation target area. In order to solve such a problem, in recent years, a holographic microscope which employs the technique of digital holography has been developed and put to practical use (for example, see Patent Literature 1 or 2).

A holographic microscope obtains an interference fringe pattern (hologram) formed on the detection plane of an image sensor or similar device by object light, which is a beam of light reflected by or transmitted through an object illuminated with a beam of light from a light source, and reference light, which is a beam of light from the same light source that reaches the detection surface without interaction with the object. Predetermined computational processing based on the hologram is performed to create an intensity image or phase image as a reconstructed image of the object. Such a holographic microscope allows for the creation of a reconstructed image at any desired distance in the stage of the computational processing for the phase retrieval or other purposes after the acquisition of the hologram. Therefore, it is unnecessary to perform the focusing for every shot of image, so that the measurement time can be significantly shortened. The device also allows users to create reconstructed images with appropriately varied focusing positions and examine the observed object in detail at a later point in time after the completion of the measurement.

When pluripotent cells being cultured are to be observed with a cell observation device employing a holographic microscope, a cell culture container (e.g. cell culture plate) in which the cells are cultured is set at a predetermined position in the holographic microscope, and hologram data for a portion or the entirety of the cell culture container is collected. Even undyed cells can be satisfactorily observed on the phase image obtained with the cell observation device employing the holographic microscope. However, the phase information obtained by the light backpropagation calculation or similar computational processing based on hologram data only reflects information concerning the objects which are comparatively small in optical thickness, or in other words, which yield a low phase contrast, as with the cells. Information concerning a container or other objects having much larger optical thicknesses than the cells will be barely reflected in the calculated result. This is due to the fact that it is in principle difficult for a normal type of holographic microscope to measure optical thicknesses which significantly exceed the wavelength of the used light source.

Therefore, for example, when a phase image of the entire cell culture plate is displayed, it is almost impossible to visually recognize the shape of the container portions (wells) or other structures formed on the cell culture plate, and the observer cannot easily understand where the currently observed cells are located within the well. A similar problem also occurs if a foreign object which is significantly larger than the cells, such human hair or dust particles, is present in the cell culture container. Such a foreign object will not be clearly visible on the phase image, and the observer will easily overlook the object.

### CITATION LIST

### Patent Literature

Patent Literature 1: WO 2016/084420 A

Patent Literature 2 JP H10-268740 A

### SUMMARY OF INVENTION

### Technical Problem

The present invention has been developed to solve the previously described problem. In a cell observation device configured to create and display a phase image or similar kind of image based on hologram data obtained with a holographic microscope, the primary objective of the present invention is to enable satisfactory observation of biological cells while allowing an observer to easily understand where the currently observed site is located within a cell culture container. Another objective of the present invention is to provide a cell observation device which allows an observer to easily recognize the presence of a foreign object which is significantly larger than the cells.

### Solution to Problem

The present invention developed for solving the previously described problem is a cell observation device employing a holographic microscope, including:

a) a computational processor configured to compute two-dimensional distributions of phase information and intensity information on a sample containing a cell, based on hologram data obtained by a measurement performed on the sample with the holographic microscope;

b) an image creator configured to create a phase image and an intensity image for a portion or the entirety of an observation target area of the sample, based on the two-dimensional distributions of phase information and intensity information obtained by the computational processor; and

c) a display processor configured to create a display screen on which a phase image and an intensity image created by the image creator for the same range on the sample are arranged adjacently to each other, and to display the display screen on a display section.

The holographic microscope may employ any type of system, such as an in-line type, off-axis type or phase-shift type.

In the cell observation microscope according to the present invention, a typical example of the sample is a cell culture container, in which case the largest possible area for the hologram data to be obtained with the holographic microscope may be the entire cell culture container or a partial area of the container. Examples of the cell culture container include a cell culture plate with one or more wells formed on its surface, a petri dish, and a culture flask designed for mass culture.

Accordingly, the cell observation device according to the present invention is a device that is suitable for observing biological cells being cultured in the aforementioned kinds of cell culture containers.

In the cell observation device according to the present invention, the computational processor performs computational processing based on the hologram data obtained by a measurement performed on a sample, to calculate a two-dimensional distribution of the phase information as well as a two-dimensional distribution of the intensity information. The image creator creates a phase image and an intensity image by relating the individual pieces of the computed phase/intensity information to the corresponding pixels of a two-dimensional image for each of the phase information and intensity information. If the sample is a cell culture plate as in the previously mentioned example, the entire cell culture plate can be selected as the observation target area for which the phase image and the intensity image should be created. Needless to say, it is also possible to create the phase image and the intensity image for only a partial area of the cell culture plate instead of its entire area.

The display processor creates a display screen on which the phase image and the intensity image created by the image creator for the same range on the sample are arranged adjacently to each other in a horizontal or vertical direction, and displays the created display screen on the display section. The phase image and the intensity image may be presented in a gray-scaled or colored form. As a result of such processing, for example, a display screen on which a phase image and an intensity image for the entire cell culture plate are horizontally arranged is shown on the display section.

In this case, it is almost impossible to recognize the shape of the wells (or other structures) on the cell culture plate on the phase image. However, the phase image clearly shows the contour, pattern and other features of the clear and colorless cells which are almost invisible on the intensity image. On the other hand, the intensity image is substantially the same as an optical microscopic image. Therefore, the intensity image clearly shows the shape of the wells as well as large objects, high elevations or similar structures which are invisible on the phase image due to their large optical thicknesses. Accordingly, the observer can initially view the phase image to recognize the location of the cell of interest within the image, and subsequently view the intensity image to understand where the cell in question is located within the entire area of the cell culture plate or within the well. Detailed observation of the size, shape and other features of the cell can be performed on the phase image.

The intensity image also enables clear recognition of human hair, dust particles, plastic fragments or other foreign objects which are larger than the cultured cells and may not be clearly visible on the phase image.

In a preferable mode of the present invention, the cell observation device further includes:

an operation section for allowing a user to perform an operation for changing the magnification or the observing position for one of the phase image and intensity image displayed on a screen of the display section by the display processor,

where:

the image creator is further configured to create, according to the operation using the operation section, a new phase image or intensity image by changing the magnification or observing position of the aforementioned one of the phase image and intensity image which is the target of the aforementioned operation, as well as to create a new intensity image or phase image by changing the magnification or observing position of the other one of the phase image and intensity image by the same amount as in the operation performed on the aforementioned one of the phase image and intensity image; and

the display processor is further configured to display, on the display screen, the new phase image and the new intensity image obtained by changing the magnification or observing position in the image creator.

According to this configuration, for example, when an intensity image corresponding to the entire cell culture plate is displayed on the display section, the observer specifies a certain range within a well on the intensity image by an operation using the operation section, and issues a command to increase the magnification. According to this operation, the image creator recognizes the specified range and creates a new intensity image with a higher resolution which shows the selected range in an enlarged form at an appropriate magnification. The image creator also processes the phase image in an interlocked fashion to create a new phase image with a higher resolution which shows the selected range in an enlarged form at the same magnification as the intensity image. The display processor replaces the last displayed images on the display section with the new images, i.e. with the enlarged phase image and intensity image.

Thus, the observer can perform detailed observation of the cells on the enlarged phase image.

In another preferable mode of the cell observation device according to the present invention, the display processor is further configured to display, on the screen of the display section, a thumbnail image created by reducing the intensity image showing the entire observation target area, the thumbnail image having a superposed mark indicating an observation range corresponding to the phase image and the intensity range displayed on the same screen at that point in time.

Increasing the observing magnification of the phase image and the intensity image may lead to a situation in which an object whose relative position within the cell culture plate should be recognizable on the intensity image cannot be observed (i.e. the object goes beyond the observation range). This problem can be solved by the previously described configuration, in which the range observed at that point in time is clearly indicated on the intensity image of the entire observation target area (i.e. an image in which the cell culture plate or wells can be recognized), so that the observer can easily recognize the relative position of the observation range.

### Advantageous Effects of Invention

The cell observation device according to the present invention allows an observer to satisfactorily observe biological cells by using a phase image as well as easily understand where the currently observed range is located within the cell culture container (e.g. cell culture plate) by viewing the intensity image which is displayed along with the phase image. This improves the efficiency of cell observation as well as prevents the observer from incorrectly observing an unintended area. If unwanted foreign objects, such as human hair, dust particles or plastic fragments are present in the cell culture container, the observer can easily recognize the presence of the foreign objects on the intensity image and remove them.

### BRIEF DESCRIPTION OF DRAWINGS

FIG. 1 is a configuration diagram showing the main components of a cell observation device according to one embodiment of the present invention.

FIGS. 2A-2D are conceptual diagrams for explaining an image-creating process in the cell observation device according to the present embodiment.

FIG. 3 is a model diagram showing an image display screen in the cell observation device according to the present embodiment.

FIG. 4 is a schematic diagram of the information display area shown in FIG. 3.

FIGS. 5A-5D are conceptual diagrams for explaining an image-creating process which is performed for changing the observing magnification in the cell observation device according to the present embodiment.

FIGS. 6A-6C are conceptual diagrams showing the relationship between images which differ from each other in magnification (resolution) in the cell observation device according to the present embodiment.

FIGS. 7A and 7B show actual examples of the phase image and the intensity image to be displayed in the cell observation device according to the present embodiment, where FIG. 7A is a display image at low magnification, and FIG. 7B is a display image at high magnification.

FIG. 8 shows an actual example of the phase image and the intensity image in the case where a piece of human hair is present in the cell observation device according to the present embodiment.

### DESCRIPTION OF EMBODIMENTS

One embodiment of the cell observation device according to the present invention is hereinafter described with reference to the attached drawings.

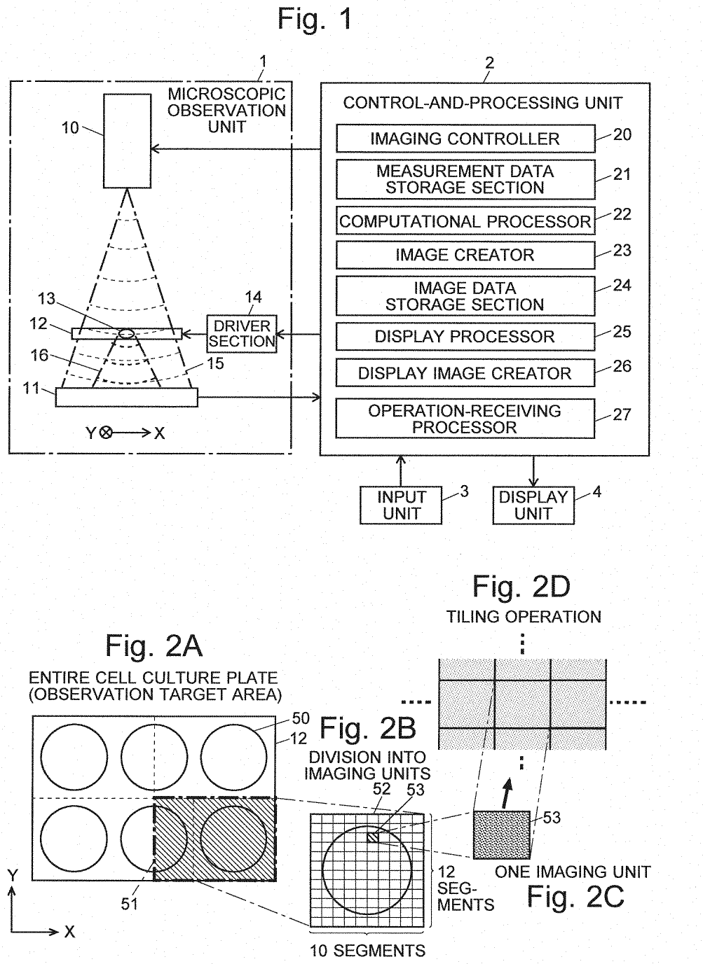

FIG. 1 is a configuration diagram showing the main components of the cell observation device according to the present embodiment.

The cell observation device according to the present embodiment includes a microscopic observation unit 1, a control-and-processing unit 2, as well as an input unit 3 and a display unit 4 which serve as the user interface.

The microscopic observation unit 1 is an in-line holographic microscope (IHM). This unit has a light-source section 10 including a laser diode and other components, as well as an image-sensor section 11. A cell culture plate 12 containing the cells 13 to be observed is placed between the light-source section 10 and the image-sensor section 11. The cell culture plate 12 can be driven in the two directions of X and Y axes which are orthogonal to each other by a driver section 14 which includes a motor or similar drive source.

The control-and-processing unit 2 is responsible for controlling the operation of the microscopic observation unit 1 as well as processing data obtained with the microscopic observation unit 1. This unit 2 includes an imaging controller 20, measurement data storage section 21, computational processor 22, image creator 23, image data storage section 24, display processor 25, display image creator 26, operation-receiving processor 27 and other components as its functional blocks.

The control-and-processing unit 2 is actually a personal computer, or a more sophisticated workstation, with the functions of the aforementioned functional blocks realized by executing, on such a computer, dedicated control-and-processing software installed on the same computer. Accordingly, the input unit 3 includes a keyboard and a pointing device (e.g. mouse). The functions of the control-and-processing unit 2 do not need to be implemented on a single computer those functions may be shared by a plurality of computers connected to each other via a communication network, as will be described later.

Next, the operations performed by an observer and the processes for observing the cells in the cell observation device according to the present embodiment are described with reference to FIGS. 2A-6C.

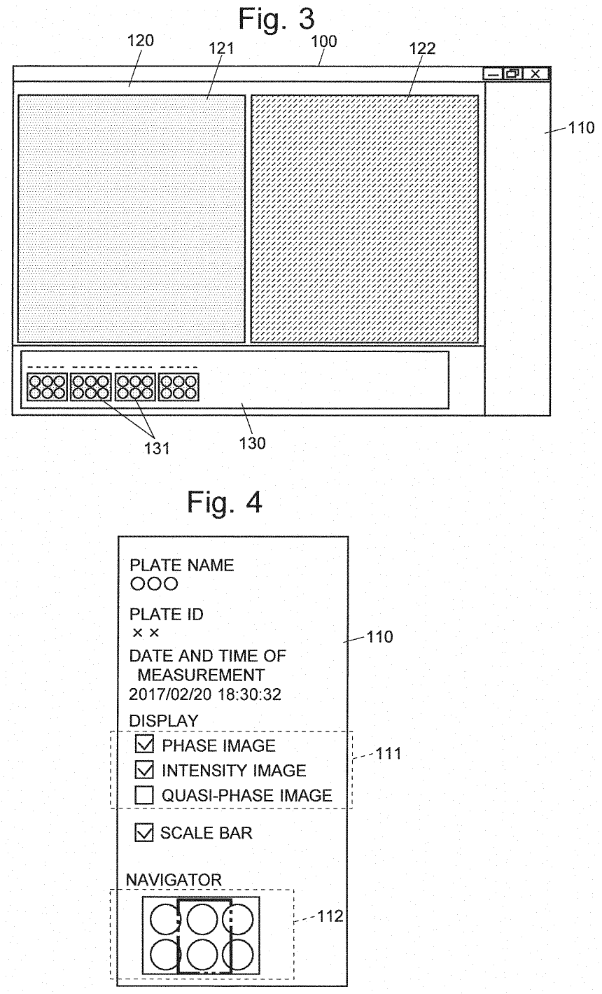

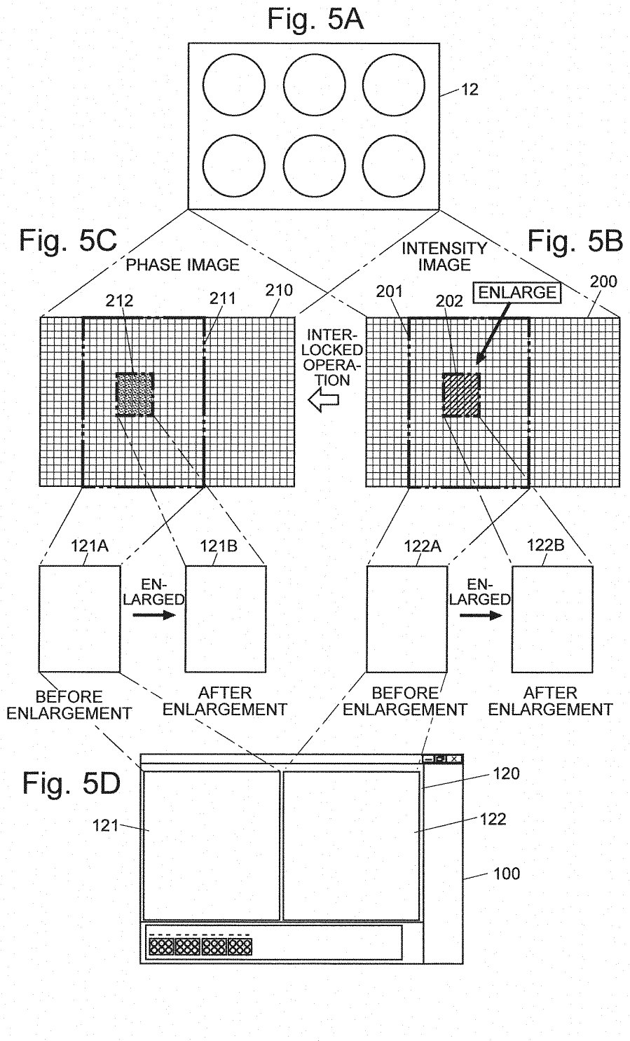

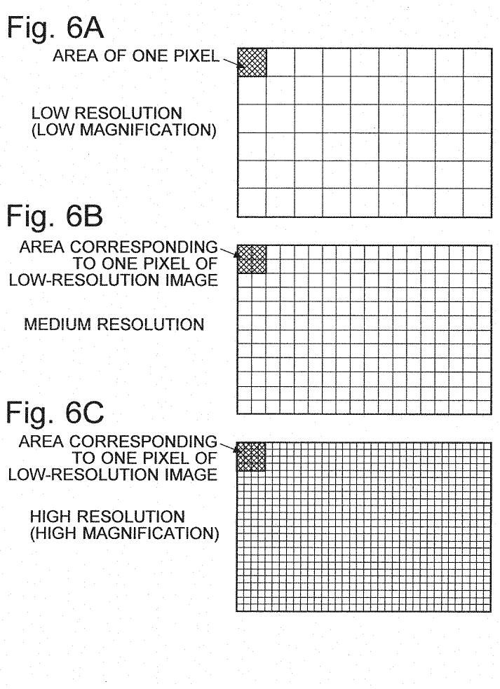

FIGS. 2A-2D are conceptual diagrams for explaining an image-creating process in the cell observation device according to the present embodiment. FIG. 3 is a model diagram showing an image display screen in the cell observation device according to the present embodiment. FIG. 4 is a schematic diagram of the information display area shown in FIG. 3. FIGS. 5A-5D are conceptual diagrams for explaining an image-creating process which is performed for changing the observing magnification in the cell observation device according to the present embodiment. FIGS. 6A-6C are conceptual diagrams showing the relationship between images which differ from each other in magnification in the cell observation device according to the present embodiment.

An observer sets a cell culture plate 12 at a predetermined position in the microscopic observation unit 1, with the cells (pluripotent cells) 13 cultured on the plate 12 as the object to be observed. After entering necessary information from the input unit 3, such as the identification number which identifies the cell culture plate 12 as well as the date and time of the measurement, the observer issues a command to execute the measurement. As shown in FIG. 2A, the cell culture plate 12 in the present embodiment has six wells 50 each of which has a circular shape as viewed from above. The cells are cultured in all wells 50. Accordingly, the observation target area is the entire cell culture plate 12, i.e. the entire rectangular range including the six wells 50. Upon receiving the measurement execution command, the imaging controller 20 controls each relevant section of the microscopic observation unit 1 to obtain hologram data for the observation target area as follows:

Though not shown in FIG. 1, the image-sensor section 11 includes four CMOS image sensors arranged on the same X-Y plane. The four CMOS sensors are respectively responsible for the imaging of the four quarter ranges 51 formed by equally dividing the entire area of the cell culture plate 12 shown in FIG. 2A into four sections. The range whose image can be taken at one time with one CMOS image sensor is a range corresponding to one of the imaging units 53 shown in FIGS. 2B and 2C which are formed by dividing a rectangular range 52 including a single well 50 within one quarter range 51 into 10 units in the X direction and 12 units in the Y direction. Accordingly, one quarter range 51 consists of 15×12=180 imaging units 53. The four CMOS image sensors are respectively located at or around the four comers of a rectangle whose longer side has a length corresponding to 15 imaging units in the X direction while its shorter side has a length corresponding to 12 imaging units in the Y direction. The four CMOS image sensors are operated to simultaneously take images of four different imaging units on the cell culture plate 12 Needless to say, these numerical values are mere examples and may be appropriately changed.

Under the control of the imaging controller 20, the light-source section 10 illuminates a predetermined area on the cell culture plate 12 with a beam of coherent light having a small spread angle of approximately 10 degrees. The coherent light which has passed through the cell culture plate 12 and the cells 13 (object beam 16) reaches the image-sensor section 11, interfering with the light which has passed through the areas near the cells 13 on the cell culture plate 12 (reference beam 15). The object beam 16 is a beam of light which has undergone a change in phase when passing through the cells 13, whereas the reference beam 15 is a beam of light which does not undergo such a change in phase due to the cells 13 since this light does not pass through the cells 13. Accordingly, on each of the detection surfaces (imaging planes) of the four CMOS image sensors arranged in the image-sensor section 11, an interference image (hologram) of the object beam 16 which has undergone the change in phase due to the cells 13 and the reference beam 15 with no such change in phase form is formed. The image-sensor section 11 produces two-dimensional light-intensity distribution data corresponding to the hologram.

The cell culture plate 12 is driven by the driver section 14 in a stepwise manner so that the plate moves a distance corresponding to the size of one imaging unit 53 in the X-Y plane in each step. Consequently, the area illuminated with the coherent light generated from the light-source section 10 gradually moves on the cell culture plate 12. Each CMOS image sensor in the image-sensor section 11 can acquire hologram data corresponding to one imaging unit 53. The stepwise motion of the cell culture plate 12 driven by the driver section 14 is repeated the same number of times as the number of imaging units 53 included in one quarter range 51, i.e. 180 times. The hologram data is collected at each step of motion. The wavelength of the coherent light radiated from the light-source section 10 are set at multiple values (e.g. four values) in a stepwise manner, and the hologram data is collected for each wavelength of light. In this manner, the hologram data can be exhaustively collected over the entire cell culture plate 12 in the microscopic observation unit 1.

The hologram data obtained by the image-sensor section 11 of the microscopic observation unit 1 in the previously described manner are sequentially sent to the control-and-processing unit 2 and stored in the measurement data storage section 21. After the measurement of the entire cell culture plate 12 has been completed, the computational processor 22 in the control-and-processing unit 2 reads the hologram data obtained at the multiple wavelengths for each imaging unit 53 from the measurement data storage section 21, and performs the light backpropagation calculation to compute phase information and intensity information reflecting the optical thickness of the cells 13. In other words, a two-dimensional distribution of the phase information as well as that of the intensity information are obtained for each imaging unit 53.

The image creator 23 creates a phase image for the observation target area, i.e. the entire cell culture plate 12, by performing the tiling operation (see FIG. 2D) in which the phase images each of which covers a small range based on the two-dimensional distribution of the phase information computed for each imaging unit 53 in the previously described manner are connected to each other. The image creator 23 also creates an intensity image for the observation target area, i.e. the entire cell culture plate 12, by performing the tiling operation in which the intensity images each of which covers a small range based on the two-dimensional distribution of the phase information calculated for each imaging unit 53 are connected to each other. An appropriate correcting operation for seamless connection of the images may be performed in the tiling operation.

The image data forming the phase image or intensity image created in this manner are stored in the image data storage section 24. The phase image and the intensity image created in this stage have the highest resolution determined by the spatial resolution of the hologram data (i.e. the spatial resolving power of the CMOS image sensors) and other related factors.

For the calculation of the phase information and the intensity information as well as the creation of the phase image and the intensity image, commonly known algorithms may be used, such as the ones disclosed in Patent Literature 1 or 2. That is to say, the methods for the calculation and processing are not limited to any specific methods.

After the completion of the measurement, the observer performs a specific operation using the input unit 3 to observe the cells. According to this operation received through the operation-receiving processor 27, the display processor 25 creates an image display screen 100 as shown in FIG. 3 and displays it on the display unit 4. The image display screen 100 includes an information display area 110, image display area 120 and thumbnail image display area 130. Within the image display area 120, a first image display frame 121 and second image display frame 122 are horizontally arranged.

As shown in FIG. 4, the information display area 110 shows the name (plate name) and identification number (plate ID) of the cell culture plate 12 corresponding to the images displayed in the image display area 120 at that point in time, as well as the property information related to the measurement, such as the date and time of the measurement. The information display area 110 also includes display-image selection checkboxes 111 for selecting the kind of image (phase image, intensity image and quasi-phase image) to be displayed in the image display area 120, and a navigator image 112 which shows the observation target area on which a mark is superimposed to indicate the observation range and position of the images displayed in the image display area 120 at that point in time.

In the present example, the two boxes assigned to the phase image and the intensity image are checked. Accordingly, the first and second image display frames 121 and 122 are provided to simultaneously display the two kinds of images. As another example, if only one of the boxes is checked, a single image display frame will be displayed within the image display area 120.

In the thumbnail image display area 130, a plurality of images (in the present example, intensity images of the entire imaging target area) each of which corresponds to the date and time of a past measurement are displayed in the form of thumbnail images. The kind of images to be displayed in this area as well as their dates and times of the measurement can be specified by the observer as needed.

The display image creator 26 reads image data which constitute the images of the kinds whose display-image selection checkboxes 111 are checked (in the present example, the phase image and the intensity image), and creates display images to be shown in the image display area 120. For example, display images which show the entire observation target area may be created on the initial screen. Thus, a phase image of the entire observation target area is displayed within the first image display frame 121, while an intensity image of the same entire observation target area is displayed within the second image display frame 122. In actual situations, the aspect ratio of the image display frames 121 and 122 is different from that of the entire observation target area. Therefore, a partial image is clipped from the image of the entire observation target area and displayed in the image display frames 121 and 122. It should also be noted that the image data stored in the image data storage section 24 correspond to the images taken with the highest resolution. In order to display such images in the image display frames 121 and 122 which have a fixed number of pixels for the display (the number of pixels, or resolution, of the screen), the display images should be created with a lower resolution according to the number of pixels of the screen.

FIGS. 6A, 6B and 6C are examples of the images of the same observation target area taken with a low resolution, medium resolution and high resolution, respectively. In those figures, each of the rectangular areas forming the grid corresponds to one pixel on the display. In the present example, one pixel in the low-resolution image (see FIG. 6A) corresponds to four pixels in the medium-resolution image (see FIG. 6B) or 16 pixels in the high-resolution image (see FIG. 6C). Suppose that the image data stored in the image data storage section 24 are image data which constitute high-resolution images as shown in FIG. 6C, while the number of pixels of the image display frame on the screen of the display unit 4 for displaying the image is as shown in FIG. 6A. In such a case, it is necessary to lower the resolution of the image by the binning or similar process before the creation of the display image. This applies to both the phase image and the intensity image.

Consider the case where image data constituting an intensity image 200 as shown in FIG. 5B and image data constituting a phase image 210 as shown in FIG. 5C have been obtained for the entire cell culture plate 12 as shown in FIG. 5A. A partial image 122A corresponding to a partial range 201 in the intensity image 200 is displayed in the second image display frame 122 in the image display screen 100 shown in FIG. 5D. Similarly, a partial image 121A corresponding to a partial range 211 in the phase image 210 is displayed in the first image display frame 121 in the image display screen 100 shown in FIG. 5D. Both the partial range 201 in the intensity image 200 and the partial range 211 in the phase image 210 correspond to the same range on the cell culture plate 12. That is to say, when creating a plurality of kinds of display images, the display image creator 26 creates those display images so that they correspond to the same range. The display processor 25 presents the created phase image and intensity image to the observer by actually showing those images within the image display screen 100.

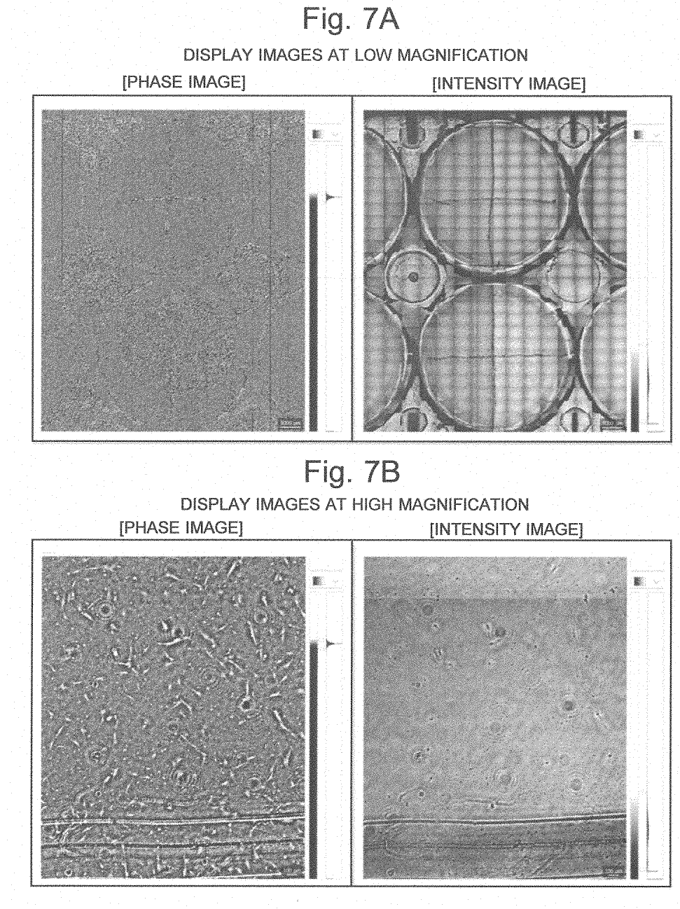

FIG. 7A shows a phase image and an intensity image actually displayed when the observing magnification is low. It can be seen that the outer shape of the wells is almost impossible to recognize on the phase image, whereas the wells are clearly observable on the intensity image. As noted earlier, these two images correspond to the same observation range. Therefore, the observer can select the position and range for detailed observation based on the intensity image.

In order to perform detailed observation of the cells which are present within a specific observation range determined based on the intensity image, the observer using the input unit 3 should perform an image-enlarging operation after specifying the desired position and desired range on the intensity image.

For example, consider the situation in which the small range 202 has been specified within the partial range 201 of the intensity image 200 shown in FIG. 5B, and a command for the enlarging operation has been issued. Upon receiving this command through the operation-receiving processor 27, the display image creator 26 creates an enlarged intensity image 122B so that the intensity image corresponding to the small specified range 202 is displayed in the fully expanded form in the second image frame 122. This operation reduces the size of the intensity image to be displayed within the second image display frame 122, which means that the resolution becomes higher than before the enlarging operation. The same operation is also performed on the phase image; i.e. the display image creator 26 creates an enlarged phase image 121B so that a phase image corresponding a small range 212 which is identical to the small specified range 202 is displayed in the fully expanded form in the entire first image display frame 121. In other words, the enlarging operation with the same magnification is performed on the phase image according to the enlarging operation performed on the intensity image. The display processor 25 displays (or updates the display with) the enlarged phase image and intensity image in the first and second image display frames 121 and 122 of the image display screen 100, respectively.

In this manner, not only the intensity image but also the phase image is enlarged in an interlocked fashion according to the enlarging operation performed on the intensity image by the observer. The same also applies to the reducing operation. Furthermore, not only the enlarging/reducing operation but also the operation of translating the observation range without changing the observing magnification is performed in a similar manner; when the operation of translating the observation range on the intensity image is performed, the observation range is translated in both the intensity image and the phase image according to the operation. The enlarging/reducing operation or translating operation may also be oppositely performed on the phase image instead of the intensity image; this also enlarges or reduces both the intensity image and the phase image, or translates the observation range in both images according to the operation.

It should be noted that the observer can refer to the mark displayed on the navigator image 112 in the information display area 110 to recognize the observing position of the phase image and the intensity image displayed in the image display area 120 at that point in time.

FIG. 7B shows measured examples of the phase image and the intensity image which are displayed when the observing magnification is high. It can be seen that the shape and other features of the cells are not clearly visible on the intensity image, whereas those features are clearly observable on the phase image. Thus, by using the cell observation device according to the present embodiment, the user can initially set the position and range of observation on the intensity image at low magnification, and subsequently observe the cells in detail on the phase image at high magnification.

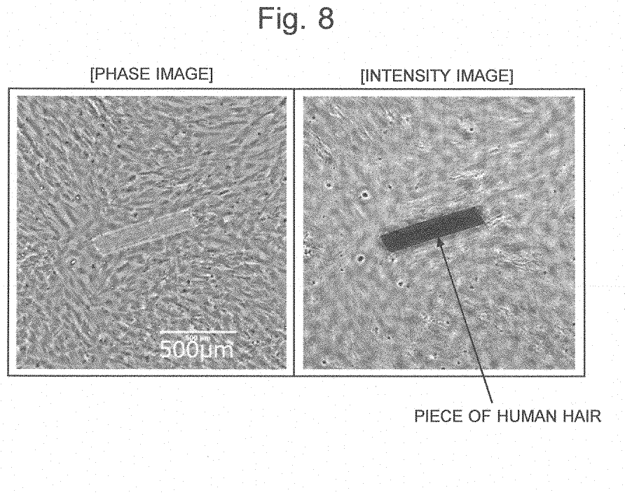

FIG. 8 shows an actual example of the phase image and the intensity image in the case where a piece of human hair is present in the cell observation device according to the present embodiment. The piece of hair is approximately 0.5 mm in length and considerably larger than the cells being cultured. As can be seen in FIG. 8, the contour of the piece of hair is still discernable on the phase image. However, it is difficult for the observer to recognize that piece, since its image is almost identical in color to the surrounding cells. By comparison, the same piece of hair is clearly observable on the intensity image. Accordingly, the observer can assuredly recognize the presence of such a foreign object.

The previously described example is concerned with the case of observing the cells being cultured on a cell culture plate. Needless to say, it is possible to use other types of cell culture containers, such as a culture flask or petri dish, in place of the cell culture plate. The component member of such a container will be clearly observable on the intensity image even when it is not sufficiently visible on the phase image.

In the configuration of the embodiment shown in FIG. 1, all processes are carried out in the control-and-processing unit 2. In general, a huge amount of computation is required for the light backpropagation calculation based on hologram data and the visualization of the calculated result. Commonly used personal computers require a considerable amount of time for such a calculation and make it difficult to efficiently perform analyzing tasks. Accordingly, it is preferable to use a computer system in which the personal computer connected to the microscopic observation unit 1 is configured as a terminal device connected with a more sophisticated server computer via a communication network, such as the Internet or intranet.

In this case, the light backpropagation calculation based on the hologram data, creation of the phase image and the intensity image, as well as other complex processes may be performed on the server, and the thereby created image data may be sent to the terminal device or another viewer terminal so that the process for creating the display images based on the image data can be performed on the terminal device. According to such a configuration, the functional blocks of the control-and-processing unit 2 shown in FIG. 1 are distributed to the terminal device and the server, or to the terminal device, server and viewer terminal. It is also possible that the functions included in one functional block of the control-and-processing unit 2 be distributed to the terminal device and the server, or to the terminal device, server and viewer terminal. Thus, the functions of the control-and-processing unit 2 may be appropriately shared by a plurality of computers.

The microscopic observation unit 1 used in the cell observation device according to the previously described embodiment is an in-line holographic microscope. It is naturally possible to replace it with a different type of holographic microscope, such as an off-axis type or phase-shift type, as long as a hologram can be obtained with the microscope.

Furthermore, it should be understood that the previously described embodiment and its variations are mere examples of the present invention, and any change, modification or addition appropriately made within the spirit of the present invention will naturally fall within the scope of claims of the present application.

### REFERENCE SIGNS LIST

1 . . . Microscopic Observation Unit
10 . . . Light-Source Section
11 . . . Image-Sensor Section
12 . . . Cell Culture Plate
13 . . . Cell
14 . . . Driver Section
15 . . . Reference Beam
16 . . . Object Beam
2 . . . Control-and-Processing Unit
20 . . . Imaging Controller
21 . . . Measurement Data Storage Section
22 . . . Computational Processor
23 . . . Image Creator
24 . . . Image Data Storage Section
25 . . . Display Processor
26 . . . Display Image Creator
27 . . . Operation-Receiving Processor
3 . . . Input Unit
4 . . . Display Unit
100 . . . Image Display Screen
110 . . . Information Display Area
111 . . . Display-Image Selection Checkbox
112 . . . Navigator Image
120 . . . Image Display Area
121 . . . First Image Display Frame
122 . . . Second Image Display Frame
130 . . . Thumbnail Image Display Area

1. A cell observation device employing a holographic microscope, comprising:
a) a computational processor configured to compute two-dimensional distributions of phase information and intensity information on a sample containing a cell, based on hologram data obtained by a measurement performed on the sample with the holographic microscope;
b) an image creator configured to create a phase image and an intensity image for a portion or an entirety of an observation target area of the sample, based on the two-dimensional distributions of phase information and intensity information obtained by the computational processor; and
c) a display processor configured to create a display screen on which a phase image and an intensity image created by the image creator for a same range on the sample are arranged adjacently to each other, and to display the display screen on a display section.

2. The cell observation device according to claim 1, wherein:
the sample is a cell culture container, and a largest possible area for the hologram data to be obtained with the holographic microscope is the entire cell culture container or a partial area of the same container.

3. The cell observation device according to claim 1, further comprising:
an operation section for allowing a user to perform an operation for changing a magnification or an observing position for one of the phase image and intensity image displayed on a screen of the display section by the display processor,
wherein:
the image creator is further configured to create, according to the operation using the operation section, a new phase image or intensity image by changing the magnification or observing position of the aforementioned one of the phase image and intensity image which is the target of the aforementioned operation, as well as to create a new intensity image or phase image by changing the magnification or observing position of another one of the phase image and intensity image by a same amount as in the operation performed on the aforementioned one of the phase image and intensity image; and
the display processor is further configured to display, on the display screen, the new phase image and the new intensity image obtained by changing the magnification or observing position in the image creator.

4. The cell observation device according to claim 1, wherein:
the display processor is further configured to display, on a screen of the display section, a thumbnail image created by reducing the intensity image showing the entire observation target area, the thumbnail image having a superposed mark indicating an observation range corresponding to the phase image and the intensity range displayed on the same screen at that point in time.
